(19) United States
(12) Patent Application Publication
(10) Pub. No.: US 2021/0403691 A1
(43) Pub. Date: Dec. 30, 2021

(54) FOOD PACKAGING COMPRISING A POLYMER COMPOSITION AND USE OF SAID POLYMER COMPOSITION FOR MANUFACTURING OF FOOD PACKAGING

(71) Applicant: SABIC GLOBAL TECHNOLOGIES B.V., BERGEN OP ZOOM (NL)

(72) Inventors: Sarah Van Mierloo, Opglabbeek (BE); Marnik Vaes, Zonhoven (BE); Daan Jongerius, Maastricht (NL); Henrica Norberta Alberta Maria Steenbakkers-Menting, Geleen (NL)

(21) Appl. No.: 17/291,651

(22) PCT Filed: Nov. 15, 2019
(86) PCT No.: PCT/EP2019/081448

§ 371 Date: May 6, 2021

(30) Foreign Application Priority Data
Nov. 19, 2018 (EP) 18207034.2
Sep. 6, 2019 (EP) 19195887.5
Sep. 6, 2019 (EP) 19195890.9

(51) Int. Cl. C08L 23/14; B65D 65/38

(52) U.S. Cl. CPC C08L 23/142; C08L 2201/08; B65D 65/38

(57) ABSTRACT

The present invention relates to a food packaging comprising a polymer composition comprising, a random propylene copolymer and a stabilizing additive mixture, said stabilizing additive mixture comprising a hydroxylamine, a phosphite compound and a hindered amine light stabilizer. In addition, the invention relates to a use of said polymer composition for manufacturing food packaging.

### TECHNICAL FIELD

The present invention relates to food packaging or radiation resistant polymer compositions. The present invention moreover relates to a use of said polymer composition for manufacturing food packaging.

### BACKGROUND

Due to increasingly stringent safety requirements for food and beverages, packaged food and beverages are often subjected to irradiation treatment to destroy any possible present unwanted organisms, microbial contamination. Sterilization is achieved by exposure of the material to a certain amount of radiation, over a period of time, e.g. between 1 minute to 24 hours. This treatment however may be deleterious to the properties of the polymer; it can negatively affect the strength, toughness, and aesthetic properties such as colour, taste and odour. When known random propylene copolymer compositions are subjected to the required level of irradiation, e.g. 25-55 kGy gamma radiation or 40 kGy electron beam radiation, often a yellowing of the polymer composition appears, which is undesirable for transparent food packaging.

U.S. Pat. No. 6,664,317 relates to a polyolefin article being essentially phenol antioxidant-free and having incorporated a stabilizing system sufficient to attenuate the deleterious effect of gamma radiation, said system consisting of a) one or more hindered amine stabilizers; b) hydroxylamine and nitrone stabilizers; and c) organic phosphites or phosphonites.

There is a need for the development of an irradiation resistant, highly transparent, and good processable random propylene copolymer composition for food contact applications, such as food packaging or closures/caps for food and beverage packaging.

### DRAWINGS

FIG. 1 shows the aTREF spectrum of a phthalate free random propylene-ethylene copolymer (PP-02) and of a phthalate containing random propylene-ethylene copolymer (PP-01).

### SUMMARY

It is an object of the present invention to provide an improved polymer composition that is irradiation resistant. It is a further object of the present invention to provide food packaging comprising said irradiation resistant polymer composition. It is a further object of the present invention to provide a random propylene copolymer composition having a stabilizing additive package that makes the composition resistant to irradiation and does not show significant yellowing, that has good transparency and that has good processing properties, such as a high melt flow.

In an aspect, the invention relates to food packaging comprising a polymer composition comprising a random propylene copolymer and a stabilizing additive mixture, said stabilizing additive mixture comprising a hydroxylamine, a phosphite compound and a hindered amine light stabilizer.

In other words, the invention relates to a stabilizing additive mixture for stabilizing irradiated random propylene copolymer compositions.

In an aspect, the invention relates to a use of a polymer composition comprising a random propylene copolymer and a stabilizing additive mixture for manufacturing food packaging, said stabilizing additive mixture comprising a hydroxylamine, a phosphite compound and a hindered amine light stabilizer, and optionally a clarifier additive.

In another aspect, the invention relates to the process for preparing an irradiated food packaging, comprising forming a food packaging article by injection moulding of a polymer composition comprising a random propylene copolymer, said copolymer being phthalate-free and irradiation said article with gamma radiation or electron beam radiation. In another aspect, the invention relates to an irradiated food packaging article obtained by said process. The embodiments disclosed herein regarding the compositions and food packaging are also applicable to these aspects.

The present invention provides a food packaging comprising random propylene copolymer that is phthalate free. In an embodiment, a phthalate free random propylene copolymer is obtained by polymerization propylene by using a phthalate free catalyst system, such as a catalyst system comprising a phthalate free procatalyst (including a phthalate free internal electron donor) as well as a phthalate free external electron.

The advantage of such a phthalate free polymer is that it reduces yellowing upon irradiation and hence has improved colour.

The advantage of the phthalate free polymer in combination with the stabilizing additive mixture is that a very low yellowing degree is obtained combined with good mechanical properties. The polymer composition according to the present invention has a unique combination of properties. It is resistant to irradiation by the fact that it does not (significantly) show yellowing after radiation with e.g. gamma radiation (e.g. 35-55 kGy) or electron beam radiation (e.g. 40 kGy). It shows high transparency and high melt flow. The present invention allows for maximum patient safety and adherence (transparency and non-yellowing) and enhanced processing behaviour (high MFR) leading to reduces costs.

Corresponding embodiments of the packaging are also applicable for the use according to the present invention.

### List of Definitions

The following definitions are used in the present description and claims to define the stated subject matter. Other terms not cited below are meant to have the generally accepted meaning in the field.

“irradiation resistant” as used in the present description means: that the polymer composition shows little to no discolouration (e.g. yellowing) after sterilization via gamma or e-beam irradiation.

“food packaging” as used in the present description means: packaging for all types of foods and beverages, either liquid, solid or frozen. The packaging can be for instance a moulded article or a film.

“multipass extrusion” as used in the present description means: repeatedly passing the polymer through an extruder and then collecting the samples after each pass. After the compounding extrusion (first extrusion step), the pellets were re-extruded several times with samples being taken after each pass through the extruder.

“phthalate-free” or “essentially phthalate-free” as used in the present description means: having a phthalate content of less than or example 150 ppm, alternatively less than for example 100 ppm, alternatively less than for example 50 ppm, alternatively for example less than 20 ppm based on the total weight of the catalyst, for example having a phthalate content of 0 ppm based on the total weight of the polymer composition, the random propylene copolymer or the catalyst composition.

The term “phthalates” referring to phthalic acid, its mono- and diesters with aliphatic, alicyclic and aromatic alcohols as well as phthalic anhydride and their respective decomposition products. Phthalates are typically used as internal or external electron donor of Ziegler-Natta catalysts used for polymer production. Examples of phthalates include but are not limited to a dialkylphthalate esters (having C2-C10 alkyl groups), phthalic acid esters include dimethyl phthalate, diethyl phthalate, ethyl-butyl phthalate, di-n-propyl phthalate, diisopropyl phthalate, di-n-butyl phthalate, diisobutyl phthalate, di-t-butyl phthalate, diisoamyl phthalate, di-t-amyl phthalate, dineopentyl phthalate, di-2-ethylhexyl phthalate, di-2-ethyldecyl phthalate, bis(2,2,2-trifluoroethyl) phthalate, diisobutyl 4-t-butylphthalate, and diisobutyl 4-chlorophthalate and diisodecylphthalate.

### DESCRIPTION OF EMBODIMENTS

In an aspect, the invention relates to food packaging comprising a polymer composition comprising a random propylene copolymer and a stabilizing additive mixture, said stabilizing additive mixture comprising a hydroxylamine, a phosphite compound and a hindered amine light stabilizer

In an embodiment, said stabilizing additive mixture is present in an amount of between 0.04 and 0.60 wt. % based on the weight of the polymer composition, preferably between 0.12 and 0.40 wt. %.

In an embodiment, said hydroxylamine is N,N-dioctadecylhydroxylamine. In a more specific embodiment as N,N-dioctadecylhydroxylamine Irgastab® FS-042 of BASF or Everstab FS042 of Everspring is used, having a CAS number of 143925-92-2.

In an embodiment, said N,N-dioctadecylhydroxylamine is present in an amount of between 0.01 and 0.15 wt. % based on the weight of the polymer composition, preferably between 0.03 and 0.10 wt. %.

In an embodiment, said phosphite compound is tris(2,4-di-tert-butylphenyl)phosphite. In a more specific embodiment as tris(2,4-di-tert-butylphenyl)phosphite Irgafos® 168 of BASF is used, having a CAS number of 31570-04-4.

In an embodiment, said tris(2,4-di-tert-butylphenyl)phosphite is present in an amount of between 0.01 and 0.15 wt. % based on the weight of the polymer composition, preferably between 0.03 and 0.10 wt. %.

In an embodiment, said hindered amine light stabilizer is poly(4-hydroxy-2,2,6,6-tetramethyl-1-piperidine ethanol-alt-1,4-butanedioic acid (also called butanedioic acid, dimethylester, polymer with 4-hydroxy-2,2,6,6-tetramethyl-1-piperidine ethanol). In a specific embodiment, as butanedioic acid, dimethylester polymer with 4-hydroxy-2,2,6,6-tetramethyl-1-piperidine ethanol Tinuvin® 622 of BASF is used, having a CAS number of CAS 65447-77-0.

In an embodiment, said butanedioic acid, dimethylester, polymer with 4-hydroxy-2,2,6,6-tetramethyl-1-piperidine ethanol is present in an amount of between 0.02 and 0.30 wt. % based on the weight of the polymer composition, preferably between 0.06 and 0.20 wt. %.

In an embodiment, said polymer composition further comprises a clarifier additive, preferably 1,2,3-tridesoxy-4,6;5,7-bis-O-[(4-propylphenyl) methylene] nonitol sorbitol. In a specific embodiment as 1,2,3-tridesoxy-4,6;5,7-bis-O-[(4-propylphenyl) methylene] nonitol sorbitol Millad® NX8000 of Milliken is used. In an embodiment, said clarifier additive is present in an amount of between 0.1 and 0.4 wt. %, preferably between 0.2 and 0.3 wt. % based on the weight of the polymer composition.

In an embodiment, a mixture of hydroxylamine and phosphite compound, preferably a 1:1 mixture, is used to prepare the composition. In a specific embodiment, a 1:1 mixture of N,N-dioctadecylhydroxylamine and tris(2,4-di-tert-butylphenyl)phosphite is used, being Irgastab FS 301 of BASF.

In an embodiment, said stabilizing additive mixture comprises N,N-dioctadecylhydroxylamine, tris(2,4-di-tert-butylphenyl)phosphite, and butanedioic acid, dimethylester polymer with 4-hydroxy-2,2,6,6-tetramethyl-1-piperidine ethanol.

In an embodiment, said stabilizing additive mixture comprises between 0.01 and 0.15 wt. % N,N-dioctadecylhydroxylamine, between 0.01 and 0.15 wt. % tris(2,4-di-tert-butylphenyl)phosphite, and between 0.02 and 0.30 wt. % butanedioic acid, dimethylester polymer with 4-hydroxy-2,2,6,6-tetramethyl-1-piperidine ethanol, each based on the weight of the polymer composition.

In an embodiment, said stabilizing additive mixture comprising between 0.03 and 0.10 wt. % N,N-dioctadecylhydroxylamine, between 0.03 and 0.10 wt. % tris(2,4-di-tert-butylphenyl)phosphite, and between 0.06 and 0.20 wt. % butanedioic acid, dimethylester polymer with 4-hydroxy-2,2,6,6-tetramethyl-1-piperidine ethanol, each based on the weight of the polymer composition.

In an embodiment, said stabilizing additive mixture comprising between 0.04 and 0.06 wt. % N,N-dioctadecylhydroxylamine, between 0.04 and 0.06 wt. % tris(2,4-di-tert-butylphenyl)phosphite, and between 0.08 and 0.12 wt. % butanedioic acid, dimethylester polymer with 4-hydroxy-2,2,6,6-tetramethyl-1-piperidine ethanol, each based on the weight of the polymer composition.

In an embodiment, the polymer composition comprises an acid scavenger, preferably calcium (Ca) stearate. In an embodiment, the polymer composition comprises an acid scavenger in an amount of between 0.025 and 0.15 wt. %, such as between 0.05 and 0.10 wt. % of said acid scavenger, based on the weight of said polymer composition.

In an embodiment, the polymer composition comprises a UV stabilizer, preferably poly[[6-[(1,1,3,3-tetramethylbutyhamino]-1,3,5-triazine-2,4-diyl][(2,2,6,6-tetramethyl-4-piperidinyhimino]-1,6 hexanediyl[(2,2,6,6-tetramethyl-4-piperidinyl)imino]]) (Chimasorb 944FD or Sabostab UV94/=HALS)

In an embodiment, said polymer composition is free of phenolic additives, meaning having less than 10 ppm of phenolic additives.

The random propylene copolymer is preferably a copolymer prepared from propylene and a comonomer chosen from the group of ethylene and α-olefins having 4 to 10 carbon atoms and mixtures thereof. Preferably, the comonomer is selected from the group of ethylene, 1-butene, 1-pentene, 4-methyl-1-pentene, 1-hexene, 1-heptene and 1-octene. More preferably, the comonomer is ethylene. This means that the random propylene copolymer is a random propylene-ethylene copolymer.

The melt flow rate (MFR) of the random propylene copolymer is for example at least 3.0 dg/min, for example at least 4.0 dg/min, for example at least 5.0 dg/min, for example at least 6.0 dg/min and/or for example at most 100 dg/min, for example at most 95 dg/min, for example at most 90 dg/min.

The comonomer content (that is the amount of comonomers incorporated into the random propylene copolymer) is for example at least 0.5 wt %, for example at least 1.0 wt %, for example at least 1.5 wt %, for example at least 2.0 wt %, for example at least 2.5 wt % and/or for example at most 6.0 wt %, for example at most 5.0 wt %, for example at most 4.5 wt %, for example at most 4.0 wt %, for example at most 3.5 wt %.

The melt flow rate of the random propylene copolymer is for example in the range from 3.0 to 100 dg/min, for example the melt flow rate of the random propylene copolymer is in the range from 6.0 to 90 dg/min, wherein the melt flow rate (MFR) is determined using ISO1133:2011 (2.16 kg, 230° C.) and/or wherein the random propylene copolymer has a comonomer content as determined using ¹³C NMR in the range from 0.5 to 6.0 wt %, preferably in the range from 1.5 to 4.5 wt %, more preferably in the range from 2.0 to 4.0 wt %, for example in the range from 2.5 to 3.5 wt %.

The total amount of xylene solubles in the random propylene copolymer is preferably in the range from 1.0 to 8.0 wt % as determined according to ISO16152:2005.

For example, the random propylene copolymer has a molecular weight distribution (Mw/Mn) of at least 3.0, for example of at least 3.5, for example of at least 4.0 and/or for example of at most 10.0, for example of at most 9.0, for example of at most 8.0, for example of at most 7.5, for example of at most 7.0. For example, the random propylene copolymer has a molecular weight distribution (Mw/Mn) in the range from 3.0 to 10.0, for example in the range from 3.5 to 8.0, for example in the range from 4.0 to 7.0, wherein Mw stands for the weight average molecular weight and wherein Mn stands for the number average molecular weight and wherein Mw and Mn are measured by SEC analysis with universal calibration according to ISO16016-1(4):2003.

For example, the random propylene copolymer, preferably the propylene-ethylene copolymer has an area under the aTREF curve at and above a temperature (T) to a temperature up to 120° C. of at most 5.0% based on the total area under the aTREF curve in the temperature range from 50° C. to 120° C.

wherein T=110−1.66*[C] equation 1
wherein T is the temperature in ° C., wherein [C] is the comonomer content in the random propylene copolymer in wt %
for example of at most 4.0%, for example of at most 3.0%, for example of at most 2.0%, for example of at most 1.0%, wherein the aTREF curve was generated using a cooling rate of 0.1° C./min and a heating rate of 1° C./min and 1,2-dichlorobenzene as eluting solvent as described herein.

The random propylene copolymer is preferably phthalate free, that is it preferably has a phthalate content of less than for example 150 ppm, alternatively less than for example 100 ppm, alternatively less than for example 50 ppm, alternatively for example less than 20 ppm based on the total weight of the random propylene copolymer.

Random propylene copolymers are generally prepared by polymerization of propylene and the comonomer in the presence of a catalyst. This type of polymer in the process according to present invention can be produced using any conventional technique known to the skilled person such as bulk polymerization, gas phase polymerization, slurry polymerization, solution polymerization or any combinations thereof. Any conventional catalyst systems, for example, Ziegler-Natta or metallocene may be used. Such techniques, including process conditions, and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the random propylene copolymer is made using a Ziegler-Natta catalyst.

In an embodiment, said random propylene copolymer has a melt flow rate (MFR) of between 36 and 44 dg/min (in other words 40+/−4 dg/min) measured according to ISO 1133-1:2011 under 2.16 kg load.

The MFR (melt flow rate) is measured according to ISO1133:2011 (under a load of 2.16 kg/230° C.). It may be measured after multi-pass extrusion. Multiple-pass extrusion involves repeatedly passing the polymer through an extruder and then collecting the samples after each pass. After the compounding extrusion under nitrogen (first extrusion step), the pellets were re-extruded three times under air with samples being taken after each pass through the extruder. A Pharma 11 Twin-screw extruder is used. As temperature program the following is used: the sample was added at room temperature, then temperature was increased to 180° C., thereafter to 230° C. The screw speed was 223 min⁻¹; the throughput: 11 kg/h; the melt temperature (die): +/−240° C.

In an embodiment, said random propylene copolymer has a density of between 890 and 920 kg/m³, preferably between 900 and 910 kg/m³, such as 905 kg/m³, measured according to ISO 1183-1:2012.

In an embodiment, said random propylene copolymer has a melt flow rate (MFR) of between 36 and 44 dg/min and a density of between 890 and 920 kg/m³, preferably between 900 and 910 kg/m³, such as 905 kg/m³. In an embodiment, said random propylene copolymer has a comonomer content, preferably an ethylene content, of between 3.8 and 4.2 wt. % (in other words 4.0+/−0.2 wt. %). In an embodiment, said random propylene copolymer has a comonomer content, preferably an ethylene content, of between 3.8 and 4.2 wt. % and melt flow rate (MFR) of between 36 and 44 dg/min. In an embodiment, said random propylene copolymer has a comonomer content, preferably an ethylene content, of between 3.8 and 4.2 wt. % and a density of between 890 and 920 kg/m³, preferably between 890 and 920 kg/m³, such as 905 kg/m³.

In an embodiment, said random propylene copolymer has a melt flow rate (MFR) of between 36 and 44 dg/min measured according to ISO 1133-1:2011 under 2.16 kg load, a density of between 890 and 920 km/m³ measured according to ISO 1183-1:2012; and a comonomer content, preferably an ethylene content of between 3.8 and 4.2 wt. %

The b value (Colour value) is measured in the following manner. Colour measurements were done by using a BYK Gardner ColorView 9000, measuring L*, a*, b* values (CIE), Yellowness Index (YI), and Whiteness Index 9W1) using a 45/0 geometry, light source D65 and a 10° viewing angle with a 32 mm measurement area. The colour measurement is done according to CIELAB (ASTM D6290-05) and ASTM E313. The b-values are disclosed in the Examples below.

In an embodiment, said packaging has a b value of at most 4.0, preferably at most 3.5, preferably at most 3.0, even more preferably 2.5 or even at most 2.0 after having being subjected to at least 25 kGy gamma radiation, preferably at least 35 kGy gamma radiation, more preferably at least 55 kGy gamma radiation.

In an embodiment, said packaging has a b value of at most 4.0, preferably at most 3.5, preferably at most 3.0, even more preferably 2.5 or even at most 2.0, after having being subjected to at least 55 kGy gamma radiation.

In an embodiment, said packaging has a b value of at most 4.0, preferably at most 3.5, preferably at most 3.0, even more preferably 2.5 or even at most 2.0, after having being subjected to at 40 kGy electron beam radiation.

In an embodiment, said packaging has a MFR of at most 60 dg/min after having being subjected to at least 4 extrusion passes (multi-pass extrusion).

In another aspect, the invention relates to a use of a polymer composition comprising, a random propylene copolymer and a stabilizing additive mixture for manufacturing food packaging, said stabilizing additive mixture comprising a hydroxylamine, a phosphite compound and a hindered amine light stabilizer, and optionally a clarifier additive. All embodiments discussed above for the packaging are also applicable to the use.

In an embodiment of said use, the random propylene copolymer is phthalate-free. In a specific embodiment, the random propylene copolymer has a presence of less than 150 ppm of phthalates based on the weight of the random propylene copolymer. A phthalate free random propylene copolymer can be obtained by polymerization of propylene with the comonomer(s) by using a phthalate free catalyst system, such as a catalyst system comprising a phthalate free procatalyst (including a phthalate free internal electron donor) as well as a phthalate free external electron. The advantage of such a phthalate free polymer may be that it reduces yellowing upon irradiation.

The packaging according to the present invention is an article that may be a cap or a closure for a food packaging, it may also be a blown film, a cast film. It may be (thin-walled) injection moulded, blow moulded, extrusion moulded, or compressed moulded into the desired shape. Examples of preferred articles are films and/or pouches, especially for packaging applications such as food and/or beverage packaging applications.

In an embodiment of the food packaging, said polymer composition is phthalate-free. In an embodiment said polymer composition has a presence of less than 150 ppm of phthalates based on the weight of the random propylene copolymer. Said polymer can be obtained by a process using a phthalate-free catalyst. In case a phthalate-free catalyst, such as the above described catalyst using a phthalate free external donor, is used, any polymer formed with it is essentially phthalate-free. This is advantageous as more and more consumers try to avoid any contact with phthalates. Therefore, the random propylene copolymer or the composition of the invention, and/or the packaging of the invention are essentially phthalate-free.

Random propylene copolymers are generally prepared by polymerization of propylene and the comonomer(s) in the presence of a catalyst. This type of polymer in the process according to present invention can be produced using any conventional technique known to the skilled person such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the random propylene copolymer is made using a Ziegler-Natta catalyst.

The invention also relates to a process for the preparation of a random propylene-copolymer, wherein the random propylene copolymer is produced from propylene and the comonomer(s) in a polymerization process, for example a gas phase polymerization process, in the presence of

a) a Ziegler-Natta procatalyst comprising compounds of a transition metal of Group 4 to 6 of IUPAC, a Group 2 metal compound and an internal donor, preferably wherein said internal donor is a non-phthalic compound (that is a compound that does not contain phthalates), preferably a non-phthalic acid ester;

b) a co-catalyst (Co), and

c) optionally an external donor (ED), preferably a non-phthalic compound.

For example, the procatalyst may be prepared by a process comprising the steps of providing a magnesium-based support, contacting said magnesium-based support with a Ziegler-Natta type catalytic species, an internal donor, and an activator, to yield the procatalyst.

Ziegler-Natta catalyst systems are well known in the art. The term normally refers to catalyst systems comprising a transition metal containing solid catalyst compound (a) and an organo-metal compound (b). Optionally one or more electron donor compounds (external donor) (c) may be added to the catalyst system as well. The transition metal in the transition metal containing solid catalyst compound is normally chosen from groups 4-6 of the Periodic Table of the Elements (Newest IUPAC notation); more preferably, the transition metal is chosen from group 4; the greatest preference is given to titanium (Ti) as transition metal. Although various transition metals are applicable, the following is focused on the most preferred one being titanium. It is, however, equally applicable to the situation where other transition metals than Ti are used. Titanium containing compounds useful in the present invention as transition metal compound generally are supported on hydrocarbon-insoluble, magnesium halides and/or an inorganic oxide, for instance silicon oxide or aluminum oxide, containing supports, generally in combination with an internal electron donor compound. The transition metal containing solid catalyst compounds may be formed for instance by reacting a titanium (IV) halide, an organic internal electron donor compound and a magnesium halide and/or silicon containing support. The transition metal containing solid catalyst compounds may be further treated or modified with an additional electron donor or Lewis acid species and/or may be subjected to one or more washing procedures, as is well known in the art.

In the following paragraphs, examples of different Ziegler-Natta catalysts are given by way of their preparation process.

The random propylene copolymer may be produced using a Ziegler-Natta catalyst system. Said Ziegler-Natta catalyst system comprising a solid support, preferably a magnesium-based solid support, a transition metal active species, e.g. titanium, and an internal electron donor, preferably a phthalate free internal donor. In case, a phthalate containing internal donor is used, it is clear to the person skilled in the art that the phthalate containing internal donor may be substituted for a non-phthalic compound, for example by a non-phthalic compound described herein to be suitable as internal electron donor

WO/2015/091982 and WO/2015/091981 describe the preparation of a catalyst system suitable for olefin polymerization, said process comprising the steps of:
providing a magnesium-based support;
optionally activating said magnesium-based support;
contacting said magnesium-based support with a Ziegler-Natta type catalytic species, and optionally one or more internal electron donors to yield a procatalyst, and
contacting said procatalyst with a co-catalyst and at least one external donor.

Preferably, said procatalyst preparation process comprises the steps of
A) providing said procatalyst obtained via a process comprising the steps of:
i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ is the same as R¹ being a linear, branched or cyclic hydrocarbyl group independently selected from alkyl, alkenyl, aryl, aralkyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2;
ii) optionally contacting the solid Mg(OR¹)ₓX¹₂₋ₓ obtained in step i) with at least one activating compound to obtain a second intermediate product; wherein: M¹ is a metal selected from the group consisting of Ti, Zr, Hf, Al or Si; M² is a metal being Si; v is the valency of M¹ or M²; R² and R³ are each a linear, branched or cyclic hydrocarbyl group independently selected from alkyl, alkenyl, aryl, aralkyl or alkylaryl groups, and one or more combinations thereof; wherein said hydrocarbyl group may be substituted or unsubstituted, may contain one or more heteroatoms, and preferably has from 1 to 20 carbon atoms; and
iii) contacting the first or second intermediate reaction product, obtained respectively in step i) or ii), with a halogen-containing Ti-compound, optionally an activator and an internal electron donor to obtain said procatalyst.

WO/2015/091982 and WO/2015/091981 are hereby incorporated by reference. It should be clear to the skilled person that also other external electron donors may be used for preparing a similar catalyst system, for example the external electron donors as exemplified herein. Additional phthalate free Ziegler-Natta catalysts, which may suitably be used to prepared the random propylene copolymer are described in WO2015/091983, hereby incorporated by reference.

EP 1 273 595 of Borealis Technology discloses a process for producing an olefin polymerization procatalyst in the form of particles having a predetermined size range, said process comprising: preparing a solution a complex of a Group IIa metal and an electron donor by reacting a compound of said metal with said electron donor or a precursor thereof in an organic liquid reaction medium; reacting said complex, in solution, with at least one compound of a transition metal to produce an emulsion the dispersed phase of which contains more than 50 mol. % of the Group IIa metal in said complex; maintaining the particles of said dispersed phase within the average size range 10 to 200 μm by agitation in the presence of an emulsion stabilizer and solidifying said particles; and recovering, washing and drying said particles to obtain said procatalyst. EP 1275595 and in particular the above described production method, is hereby incorporated by reference.

EP 0 019 330 of Dow discloses a Ziegler-Natta type catalyst composition. Said olefin polymerization catalyst composition is prepared using a process comprising: a) a reaction product of an organo aluminum compound and an electron donor, and b) a solid component which has been obtained by halogenating a magnesium compound with the formula Mg R¹R² wherein R¹ is an alkyl, aryl, alkoxide or aryloxide group and R² is an alkyl, aryl, alkoxide or aryloxide group or halogen, are contacted with a halide of tetravalent titanium in the presence of a halohydrocarbon, and contacting the halogenated product with a tetravalent titanium compound. This production method as disclosed in EP 0 019 330 is incorporated by reference.

Example 2 of U.S. Pat. No. 6,825,146 of Dow discloses another improved process to prepare a catalyst. Said process includes a reaction between titanium tetrachloride in solution with a precursor composition—prepared by reacting magnesium diethoxide, titanium tetraethoxide, and titanium tetrachloride, in a mixture of ortho-cresol, ethanol and chlorobenzene—and ethylbenzoate as electron donor. The mixture was heated and a solid was recovered. To the solid titanium tetrachloride, a solvent and benzoylchloride were added. The mixture was heated to obtain a solid product. The last step was repeated. The resulting solid procatalyst was worked up to provide a catalyst. Example 2 of U.S. Pat. No. 6,825,146 is incorporated by reference.

U.S. Pat. No. 4,771,024 discloses the preparation of a catalyst on column 10, line 61 to column 11, line 9. The section “catalyst manufacture on silica” is incorporated into the present application by reference. The process comprises combining dried silica with carbonated magnesium solution (magnesium diethoxide in ethanol was bubbled with CO₂). The solvent was evaporated at 85° C. The resulting solid was washed and a 50:50 mixture of titanium tetrachloride and chlorobenzene was added to the solvent together with ethylbenzoate. The mixture was heated to 100° C. and liquid filtered. Again TiCl₄ and chlorobenzene were added, followed by heating and filtration. A final addition of TiCl₄ and chlorobenzene and benzoylchloride was carried out, followed by heating and filtration. After washing the catalyst was obtained.

U.S. Pat. No. 4,866,022 discloses a catalyst component comprises a product formed by: A. forming a solution of a magnesium-containing species from a magnesium carbonate or a magnesium carboxylate; B. precipitating solid particles from such magnesium-containing solution by treatment with a transition metal halide and an organosilane having a formula: RnSiR′4-n, wherein n=0 to 4 and wherein R is hydrogen or an alkyl, a haloalkyl or aryl radical containing one to about ten carbon atoms or a halosilyl radical or haloalkylsilyl radical containing one to about eight carbon atoms, and R′ is OR or a halogen: C. reprecipitating such solid particles from a mixture containing a cyclic ether; and D. treating the reprecipitated particles with a transition metal compound and an electron donor. This process for preparing a catalyst is incorporated into the present application by reference. In a preferred embodiment, the catalyst preparation process comprises the steps of reacting a magnesium-containing species, a transition metal halide and an organosilane, again with transition metal compound and an electron donor.

The Ziegler-Natta type procatalyst may for example also be that of the catalyst system that is obtained by the process as described in WO 2007/134851 A1. In Example I the process is disclosed in more detail. Example I including all sub-examples (IA-IE) of WO 2007/134851 A1 is incorporated into the present description. More details about the different embodiments are disclosed starting on page 3, line 29 to page 14 line 29 of WO 2007/134851 A1. These embodiments are incorporated by reference into the present description.

The catalyst used for preparation of the random propylene copolymer may for example also be the catalyst system that is obtained by the process as described in EP3212712B1, for example the process as described in paragraphs [0159] [0162], EP3212712B1 and in particular paragraphs [0159] [0162] of EP3212712B1 are hereby incorporated by reference.

In case an internal electron donor compound (also referred to herein as “internal electron donor”, or “internal donor”) is used in the catalysts used for the preparation of the random propylene copolymer, in order to achieve a phthalate-free random propylene copolymer, the internal electron donor is preferably phthalate free, that is the internal donor is a non-phthalic compound (a compound that does not contain phthalates), preferably a non-phthalic acid ester;

The non-phthalic internal donor is preferably selected from (di)esters of non-phthalic carboxylic (di)acids, non-phthalic (aromatic) acid esters, 1,3-diethers, derivatives, aminobenzoates and mixtures thereof.

Examples of diester of non-phthalic carboxylic di acids include esters belonging to a group consisting of malonates, maleates, succinates, citraconates, for example bis(2-ethylhexyl)citraconate, glutarates, cyclohexene-1,2-dicarboxylates and benzoates, silyl esters, and any derivatives and/or mixtures thereof.

Suitable non-limiting examples of phthalate free aromatic acid esters, for example benzoic acid esters include an alkyl p-alkoxybenzoate (such as ethyl p-methoxybenzoate, methyl p-ethoxybenzoate, ethyl p-ethoxybenzoate), an alkyl benzoate (such as ethyl benzoate, methyl benzoate), an alkyl p-halobenzoate (ethyl p-chlorobenzoate, ethyl p-bromobenzoate), and benzoic anhydride. The benzoic acid ester is preferably selected from ethyl benzoate, benzoyl chloride, ethyl p-bromobenzoate, n-propyl benzoate and benzoic anhydride. The benzoic acid ester is more preferably ethyl benzoate.

Suitable examples of phthalate free 1,3-diethers compounds include but are not limited to diethyl ether, dibutyl ether, diisoamyl ether, anisole and ethylphenyl ether, 2,3-dimethoxypropane, 2,3-dimethoxypropane, 2-ethyl-2-butyl-1,3-dimethoxypropane, 2-isopropyl-2-isopentyl-1,3-dimethoxypropane and 9,9-bis (methoxymethyl) fluorene.

Suitable examples of phthalate free succinates, for example succinate acid esters include but are not limited to diethyl 2,3-di-isopropylsuccinate, diethyl 2,3-di-n-propylsuccinate, diethyl 2,3-di-isobutylsuccinate, diethyl 2,3-di-sec-butylsuccinate, dimethyl 2,3-di-isopropylsuccinate, dimethyl 2,3-di-n-propylsuccinate, dimethyl-2,3-di-isobutylsuccinate and dimethyl 2,3-di-sec-butylsuccinate.

The phthalate free silyl ester as internal donor can be any silyl ester or silyl diol ester known in the art, for instance as disclosed in US 2010/0130709.

Phthalate free aminobenzoates as internal donors may be represented by formula (XI):

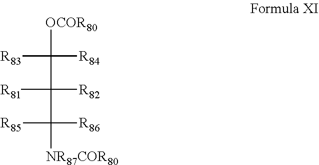

wherein:
R⁸⁰, R⁸¹, R⁸², R⁸³, R⁸⁴, R⁸⁵, R⁸⁶ and R⁸⁷ are independently selected from a group consisting of hydrogen or C₁-C₁₀ hydrocarbyl.

For example, the internal electron donor is selected from the group consisting of 4-[benzoyl(methyl)amino]pentan-2-yl benzoate; 2,2,6,6-tetramethyl-5-(methylamino)heptan-3-ol dibenzoate; 4-[benzoyl (ethyl)amino]pentan-2-yl benzoate, 4-(methylamino)pentan-2-yl bis (4-methoxy)benzoate); 3-[benzoyl(cyclohexyl)amino]-1-phenylbutylbenzoate; 3-[benzoyl(propan-2-yl)amino]-1-phenylbutyl; 4-[benzoyl(methyl)amino]-1,1,1-trifluoropentan-2-yl; 3-(methylamino)-1,3-diphenylpropan-1-ol dibenzoate; 3-(methyl)amino-propan-1-ol dibenzoate; 3-(methyl)amino-2,2-dimethylpropan-1-ol dibenzoate, and 4-(methylamino)pentan-2-yl-bis (4-methoxy)benzoate).

The molar ratio of the internal donor relative to the magnesium can be from 0.020 to 0.50. Preferably, this molar ratio is from 0.050 to 0.20.

As discussed in WO 2013/124063, hereby incorporated by reference, 1,5-diesters, for example pentanediol dibenzoate, preferably meso pentane-2,4-diol dibenzoate (mPDDB), can be used as internal donors.

As used herein, a “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst as are known to the skilled person. Preferably, the cocatalyst is selected from trimethylaluminium, triethylaluminum, triisobutylaluminum, trihexylaluminum, di-isobutylaluminum hydride, trioctylaluminum, dihexylaluminum hydride and mixtures thereof, most preferably, the cocatalyst is triethylaluminium (abbreviated as TEAL).

In case an optional external electron donor compound (also referred to herein as “external electron donor”, or “external donor”) is used in the catalysts used for the preparation of the random propylene copolymer, in order to achieve a phthalate-free random propylene copolymer, the external electron donor is preferably phthalate free, that is a non-phthalic compound.

Examples of external donors are known to the person skilled in the art and include but are not limited to external electron donors chosen from the group of a compound having a structure according to Formula III (R⁹⁰)₂N—Si(OR⁹¹)₃, a compound having a structure according to Formula IV: (R⁹²)Si(OR⁹³)₃ and mixtures thereof wherein each of R⁹⁰, R⁹¹,R⁹² and R⁹³ groups are each independently a linear, branched or cyclic, substituted or unsubstituted alkyl having from 1 to 10 carbon atoms, preferably wherein R⁹⁰, R⁹¹,R⁹² and R⁹³ groups are each independently a linear unsubstituted alkyl having from 1 to 8 carbon atoms, for example ethyl, methyl or n-propyl, for example diethylaminotriethoxysilane (DEATES), n-propyl triethoxysilane, (nPTES), n-propyl trimethoxysilane (nPTMS); and organosilicon compounds having general formula Si(ORa)₄₋ₙB^{b}ₙ, wherein n can be from 0 up to 2, and each of R^{a} and Rb, independently, represents an alkyl or aryl group, optionally containing one or more hetero atoms for instance O, N, S or P, with, for instance, 1-20 carbon atoms; such as diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl) dimethoxysilane (DiPDMS). More preferably, the external electron donor is chosen from the group of di(iso-propyl) dimethoxysilane (DiPDMS) or diisobutyl dimethoxysilane (DiBDMS).

The molar ratio of the co-catalyst to the procatalyst (Al/Ti) in the catalyst polymerization system may for example be from about 5:1 to about 500:1 or from about 10:1 to about 200:1 or from about 15:1 to about 150:1 or from about 20:1 to about 100:1.

The molar ratio of the external donor to the pro-catalyst (Si/Ti) in the catalyst polymerization system, may for example be in the range from 1 to 100, for example in the range from 20-80.

The molar ratio of the co-catalyst to the external donor (Al/Si) in the catalyst polymerization system may for example be from preferably is from 0.1 to 200; more preferably from 1 to 100, for example from 5 to 50.

The catalyst system comprising the Ziegler-Natta pro-catalyst may be activated with an activator, for example an activator chosen from the group of benzamides and monoesters, such as alkylbenzoates.

For example, the activator may be a benzamide according to formula X:

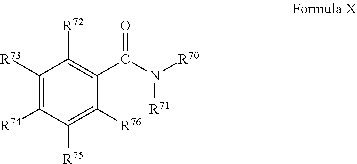

wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, preferably selected from alkyl, alkenyl, aryl, aralkyl, alkoxycarbonyl or alkylaryl groups, and one or more combinations thereof;

Examples of such activators include but are not limited to N,N,-dimethylbenzamide, methylbenzoate, ethylbenzoate, ethyl acetate, and butyl acetate, more preferably the activator is ethylbenzoate or benzamide.

In a preferred embodiment a catalyst system comprising a Ziegler-Natta catalyst that has been activated with an activator, further comprises as internal donor an internal donor chosen from the group of phthalate-free internal donors, for example chosen from the group of 1,3-diethers, such as represented by the Formula VII,

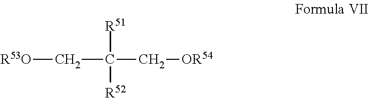

wherein R⁵¹ and R⁵² are each independently selected from a hydrogen or a hydrocarbyl group selected from alkyl, alkenyl, aryl, aralkyl, alkoxycarbonyl or alkylaryl groups, and one or more combinations thereof and wherein R53 and R54 are each independently selected from a hydrocarbyl group, preferably selected from alkyl, alkenyl, aryl, aralkyl, alkoxycarbonyl or alkylaryl groups, and one or more combinations thereof; preferably 9,9-bis (methoxymethyl) fluorene.

For example, the random propylene copolymer is present in the polymer composition in an amount of at least 80 wt % based on the weight of the polymer composition, for example at least 85 wt % based on the weight of the polymer composition, for example at least 90 wt % based on the weight of the polymer composition, for example at least 95 wt % based on the weight of the polymer composition, preferably at least 97 wt % based on the weight of the polymer composition, preferably at least 98 wt % based on the weight of the polymer composition, more preferably at least 99 wt % based on the weight of the polymer composition, for example at least 99.5 wt % based on the weight of the polymer composition, for example at least 99.6 wt % based on the weight of the polymer composition. The remaining percentage up to 100 wt. % preferably being formed of one or more additives, such as the stabilizing additive mixture described below.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The scope of the present invention is defined by the appended claims. One or more of the objects of the invention are achieved by the appended claims.

### EXAMPLES

The present invention is further elucidated based on the Examples below which are illustrative only and not considered limiting to the present invention.

Measurement Methods

Melt Flow Rate (MFR)

The melt flow rate (MFR) was determined according to ISO1133-1:2011, 230° C., 2.16 kg.

Cold Xylene Solubles (XS)

The XS was determined in the following way: 1 gram of polymer and 100 ml of xylene were introduced in a glass flask equipped with a magnetic stirrer. The temperature was raised up to the boiling point of the solvent. The so obtained clear solution was then kept under reflux and stirring for further 15 minutes. Heating was stopped and the isolating plate between heating and flask was removed. Cooling took place with stirring for 5 minutes. The closed flask was then kept for 30 minutes in a thermostatic water bath at 25° C. for 30 minutes. The so formed solid was filtered on filtering paper. Of the filtered liquid, 25 mL was poured in a previously weighed aluminum container, which was heated in a stove of 140° C. for at least 2 hours, under nitrogen flow and vacuum, to remove the solvent by evaporation. The container was then kept in an oven at 140° C. under vacuum until constant weight was obtained. The weight percentage of polymer soluble in xylene at room temperature was then calculated.

Ethylene Content

The ethylene content (C2 content) in the random propylene-ethylene copolymer was determined using ¹³C NMR according to known procedures.

Analytical Temperature Rising Elution Fractionation (aTREF)

Analytical temperature rising elution fractionation (aTREF) analysis was conducted according to the method described in U.S. Pat. No. 4,798,081 and Wilde, L.; Ryle, T. R.; Knobeloch, D. C; Peat, L R.; Determination of Branching Distributions in Polyethylene and Ethylene Copolymers, J. Polym. ScL, 20, 441-455 (1982), which are incorporated by reference herein in their entirety. The composition to be analyzed was dissolved in 1,2-dichlorobenzene of analytical quality filtrated via 0.2 filter and allowed to crystallize in a column containing an inert support (Column filled with 150 μm stainless steel beans (volume 2500 μL) by slowly reducing the temperature to 30° C. at a cooling rate of 0.1° C./min. The column was equipped with an infrared detector. An aTREF chromatogram curve was then generated by eluting the crystallized polymer sample from the column by slowly increasing the temperature of the eluting solvent (1,2-dichlorobenzene) from 30 to 140° C. at a rate of 1° C./min.

The instrument used was Polymer Char Crystaf-TREF 300, with the following characteristics:
Stabilizers: 1 g/L of a phenolic antioxidant (Topanol)+1 g/L of a secondary antioxidant (Tris(2,4-di-tert-butylphenyl) phosphite, Irgafos 168 of BASF)
Sample: approx. 40 mg in 20 mL
Sample volume: 0.3 mL
Pump flow: 0.50 mL/min

The software from the Polymer Char Crystaf-TREF-300 was used to generate the spectra.

CIELAB b-Value

The CIELAB b-value (Colour value) is measured in the following manner. Colour measurements were done by using a Konica Minolta CM-5, measuring L*, a*, b* values (CIE), using a d8 geometry (measurements in reflectance), light source D65 and a 10° viewing angle with a 30 mm measurement opening. A white calibration tile is used as background. The colour measurement is done according to CIELAB (ASTM D6290-05) and ASTM E313. The b-values are disclosed in the Examples below.

Investigated specimens were transparent plaques (62×62 mm) with 3.2 mm thickness. These transparent plaques were subjected to gamma radiation. Chosen setting was gamma radiation with doses of 25 and 50 kGy. Irradiation was conducted at Synergy Health Ede B.V. in Etten-leur (The Netherlands). For gamma radiation which has a high penetration depth, the polymer was packaged in transparent bags without particular handling. Irradiation may take several hours. The gamma rays may result from the decay of the radioactive isotope Cobalt-60 (60Co). They have a high penetration depth and can penetrate complete pallets or lots.

Preparation of the Catalyst

Two different catalysts were prepared, Catalyst A, which was prepared using a phthalate containing internal electron donor, and Catalyst B, which was prepared using a phthalate-free internal electron donor. Catalyst A is a catalyst which was prepared according to Illustrative Embodiment 1 in U.S. Pat. No. 4,728,705A1, with the exception that di-isobutyl-phthalate was used instead of ethyl benzoate. Catalyst B was synthesized according to Example 1 in EP0728724.

Polymerization Process

A gas phase Unipol™ reactor was used to prepare the polymers. The conditions in the reactor were as follows: i) gas phase fluidized bed reactor had a superficial gas velocity around 30 m/s; ii) the polymerization reaction temperature was 64 to 70° C.; the pressure was 29 bar with a corresponding partial pressure of propylene of 23 bar; iv) hydrogen was added for controlling the molar mass in a manner known per se. The residence time was 3 hours, and the throughput was 15 kg/hour. In the process di-isopropyl dimethoxysilane (DiPDMS) was used as an external donor and triethylaluminium (TEAL) was used as a co-catalyst. The catalyst components are introduced in the polymerization stage. Furthermore, antistatic additives were used to prevent the particles from adhering to each other or to the walls of the reactor.

Polymerization conditions are indicated in Table 1 below. In this table, the following abbreviations are used:
Al/Ti is the ratio of the co-catalyst (TEAL) to the procatalyst
Si/Ti is the ratio of the external donor (DiPDMS) to the procatalyst
Al/Si is the ratio of the co-catalyst (TEAL) to the external donor (DiPDMS)
H2/C3 is the molar ratio of hydrogen to propylene.

TABLE 1

| | | P | T | Al/Ti | Si/Ti | Al/Si | H2/C3 | C2/C3 |
|---|---|---|---|---|---|---|---|---|
| | Catalyst | (bar) | (° C.) | (mol/mol) | (mol/mol) | (mol/mol) | (mol/mol) | (mol/mol) |
| PP-01 | A | 30 | 64 | 50 | 16.5 | ~5.9-10 | 0.0658 | 0.0123 |
| PP-02 | B | 31 | 64 | 55 | 18.3 | 3.0 | 0.0546 | 0.0203 |

PP-01 thus produced is phthalate containing random propylene-ethylene copolymer.

PP-02 is a phthalate-free random propylene ethylene copolymer.

PP-01 and PP-02 were characterized using the methods as described herein; results are shown in Table 2 below.

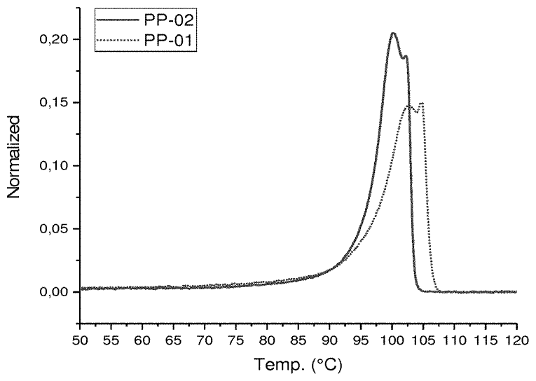

The aTREF spectra as recorded for PP-01 and PP-02 are shown in FIG. 1 (FIG. 1). The x-axis shows the elution temperature (° C.), the y-axis shows the signal. The peak (the highest point on the curve) was marked as ‘peak Tm’ and is noted for PP01 and PP02 in the below table.

The area under the aTREF curve was also determined and the area under the curve for a temperature T=110−1.66* [C] equation 1

to a temperature of 120° C. was listed in the below table. In addition, the total area under the curve for a temperature from 50 to 120° C. was also listed.

In equation 1, T is the temperature in ° C., wherein [C] is the comonomer content in the random propylene copolymer in wt %

The percentage of area under the aTREF curve at and above a temperature (T) to a temperature up to 120° C. based on the total area under the aTREF curve in the temperature range from 50° C. to 120° C. was calculated by dividing the area under the curve for a temperature T (in ° C.) to 120° C. by the total area under the curve from 50° C. to 120° C. and multiplication by 100.

TABLE 2

| | | | | | | | | Area |
|---|---|---|---|---|---|---|---|---|
| | | | | | | | | under |
| | | | C2 | Peak | | Area ≥ | Area for | aTREF |
| | MFR | XS | content | Tm | | T to | 50 to | curve |
| | (dg/min) | (wt. %) | (wt. %) | (° C.) | T | 120° C. | 120° C. | (%) |
| PP-01 | 40 | | 3.2 | 102.5 | 104.688 | 0.15328 | 1.51332 | 10.13 |
| PP-02 | 40 | 6.4 | 3.1 | 100.2 | 104.854 | 0.0025 | 1.5399 | 0.16 |

Materials Used

The following materials are used in the following examples.

As polypropylene (PP), PP-01 was used.

Materials Used:

The Following Material were Used in the Following Examples.

As phosphite compound was used tris(2,4-di-tert-butylphenyl)phosphite (Irgafos® 168 of BASF)

As hydroxylamine (HA) was used N,N-dioctadecylhydroxylamine (Irgastab® FS042 of BASF).

As clarifier additive (CA) was used 1,2,3-tridesoxy-4,6;5,7-bis-O-[(4-propylphenyl) methylene] nonitol sorbitol (Millad® NX8000 of Milliken).

As acid scavenger (AS) calcium stearate was used.

As phenolic antioxidant (PA) pentaerythritol tetrakis(3-(3,5-di-tert-butyl-4-hydroxyphenyl)propionate) is used (Irganox 1010 of BASF).

As hindered amine light stabilizer (HALS) is butanedioic acid, dimethylester polymer with 4-hydroxy-2,2,6,6-tetramethyl-1-piperidine ethanol (Tinuvin® 622 of BASF).

### Examples 1-4

Polymer compositions were prepared by blending (unstabilized) reactor polymer powder PP-01 with the remaining components as disclosed in Table 3 during a compounding step. CE denote comparative examples and E denote examples according to the invention. CE1 is a comparative example since there is no phosphite present. CE3 is a comparative example since there is no hydroxylamine present. CE4 is a comparative example since there is no hydroxylamine nor HALS present, CE4 contains a phenolic antioxidant in combination with a phosphite.

TABLE 3
Compositions according to Examples 1-4.

| | | phos- | | | | | |
|---|---|---|---|---|---|---|---|
| | PP | phite | HA | CA | AS | PA | HALS |
| # | (wt. %) | (wt. %) | (wt. %) | (wt. %) | (wt. %) | (wt. %) | (wt. %) |
| CE1 | 99.545 | 0.000 | 0.050 | 0.230 | 0.075 | 0.000 | 0.100 |
| E2 | 99.495 | 0.050 | 0.050 | 0.230 | 0.075 | 0.000 | 0.100 |
| CE3 | 99.545 | 0.050 | 0.000 | 0.230 | 0.075 | 0.000 | 0.100 |
| CE4 | 99.595 | 0.050 | 0.000 | 0.230 | 0.075 | 0.050 | 0.000 |

The irradiation resistance in terms of discolouration (yellowing) of two polymer compositions (E2 and CE4) were tested. From the results below (Tables 4a-4c) it is very clear that the composition according to the present invention has a significantly improved non-yellowing compared to the comparative example

TABLE 4a
Diminished yellowing after irradiation with
35 kGy gamma for E2 compared to CE4.

| | Before | | 35 kGy gamma irradiation followed by 12 | |
|---|---|---|---|---|
| | irradiation | | weeks storage time at lab conditions | |
| | CE4 | E2 | CE4 | E2 |
| b-value | 2.8 | 1.9 | 7.0 | 2.7 |

TABLE 4b
Diminished yellowing after irradiation with
55 kGy gamma for E2 compared to CE4.

| | Before | | 55 kGy gamma irradiation followed by 12 | |
|---|---|---|---|---|
| | irradiation | | weeks storage time at lab conditions | |
| | CE4 | E2 | CE4 | E2 |
| b-value | 2.8 | 1.9 | 6.5 | 3.08 |

TABLE 4c
Diminished yellowing after irradiation with
40 kGy e-beam for E2 compared to CE4.

| | Before | | 40 kGy ebeam irradiation followed by 12 | |
|---|---|---|---|---|
| | irradiation | | weeks storage time at lab conditions | |
| | CE4 | E2 | CE4 | E2 |
| b-value | 2.8 | 1.9 | 5.5 | 2.9 |

To show that the composition according to the present invention has similar (and not significantly decreased) processing stability, multi-pas MFR was carried out. The results are shown in Table 5 below.

TABLE 5
MFR data for E2 and CE4.

| | | | | | Increase [%] |
|---|---|---|---|---|---|
| | MFR after | MFR after | MFR after | MFR after | after pass 4 |
| | pass 1 | pass 2 | pass 3 | pass 4 | compared to |
| | (dg/min) | (dg/min) | (dg/min) | (dg/min) | pass 1 |
| E2 | 43.33 | 47.55 | 51.01 | 56.07 | 29.40 |
| CE4 | 51.39 | 56.55 | 63.23 | 70.53 | 37.20 |

From the data in Table 5 it is clear that when E2 is compared to CE4 that the MFR is somewhat more stable after 4 passes. A composition having at least the same processing stability with increased irradiation resistance is obtained. Such composition is excellent for use in food packaging, especially for use in food packaging that is irradiation resistant, highly transparent, and which food packaging can easily be produced.

As will be evident to the person skilled in the art, it is also possible to replace phthalate containing polypropylene (as exemplified by PP-01 in this example) by a phthalate free polypropylene (as exemplified by PP-02 in this example) to obtain a phthalate-free composition suitable for use in food packaging.

The irradiation resistance in terms of discolouration (yellowing) of two polymer compositions (E2 and CE4) were tested in time on injection moulded plaques with dimensions 70*50*3, measured on 3 mm part of the sample. The irradiated samples were kept at 23° C. at 50% humidity for the time period as indicated herein.

The below results show that the composition according to the present invention has a significantly improved non-yellowing as compared to the comparative example.

Data displayed in table 6a-6c were obtained using following experimental setting at Intertek (The Netherlands):

BYK Gardner ColorView 900-45°/0° geometry—Light source D65—10° viewing angle—Measurement area 32 mm—L*, a*, b*, Yellowness Index (YI) en Whiteness Index (WI) CIELAB (ASTM D6290-05) and ASTM E313)

TABLE 6a
Diminished yellowing after irradiation with
35 kGy gamma for E2 compared to CE4.

| | Before | | 35 kGy gamma irradiation followed by 12 | |
|---|---|---|---|---|
| | irradiation | | weeks storage time at lab conditions | |
| | CE4 | E2 | CE4 | E2 |
| b-value | 2.8 | 1.9 | 7.0 | 2.7 |

TABLE 6b
Diminished yellowing after irradiation with
55 kGy gamma for E2 compared to CE4.

| | Before | | 55 kGy gamma irradiation followed by 12 | |
|---|---|---|---|---|
| | irradiation | | weeks storage time at lab conditions | |
| | CE4 | E2 | CE4 | E2 |
| b-value | 2.8 | 1.9 | 6.5 | 3.08 |

TABLE 6c
Diminished yellowing after irradiation with
40 kGy e-beam for E2 compared to CE4.

| | Before | | 40 kGy ebeam irradiation followed by 12 | |
|---|---|---|---|---|
| | irradiation | | weeks storage time at lab conditions | |
| | CE4 | E2 | CE4 | E2 |
| b-value | 2.8 | 1.9 | 5.5 | 2.9 |

Data displayed in table 7a-7b were obtained using the following experimental setting: Colour measurements were done by using a Konica Minolta CM-5, measuring L*, a*, b* values (CIE), using a d8 geometry (measurements in reflectance, SCE), light source D65 and a 10° viewing angle with a 30 mm measurement opening. A white calibration tile is used as background. The colour measurement is done according to CIELAB (ASTM D6290-05) and ASTM E313. The b-values are disclosed in the Examples below.

TABLE 7a
Diminished yellowing after irradiation with
35 kGy gamma for E2 compared to CE4.

| | Before | | 35 kGy gamma irradiation followed by 42 | |
|---|---|---|---|---|
| | irradiation | | weeks storage time at lab conditions | |
| | CE4 | E2 | CE4 | E2 |
| b-value | −1.7 | −3.7 | 6.5 | −1.4 |

TABLE 7b
Diminished yellowing after irradiation with
55 kGy gamma for E2 compared to CE4.

| | Before | | 55 kGy gamma irradiation followed by 42 | |
|---|---|---|---|---|
| | irradiation | | weeks storage time at lab conditions | |
| | CE4 | E2 | CE4 | E2 |
| b-value | −1.7 | −3.7 | 4.0 | −0.2 |

The above results show that one or more objects of the present invention have been obtained.

1. A food packaging comprising a polymer composition comprising a random propylene copolymer and a stabilizing additive mixture, said stabilizing additive mixture comprising a hydroxylamine, a phosphite compound and a hindered amine light stabilizer.

2. The packaging according to claim 1, wherein the random propylene copolymer is prepared from propylene and a comonomer chosen from the group of ethylene and α-olefins having 4 to 10 carbon atoms and mixtures thereof and/or wherein the random propylene copolymer wherein the random propylene copolymer has a comonomer content as determined using ¹³C NMR in the range from 0.5 to 6.0 wt %.

3. The packaging according to claim 1, wherein the random propylene-copolymer has a total amount of xylene solubles in the range from 1.0 to 8.0 wt % as determined according to ISO16152:2005 and/or wherein the random propylene copolymer has a molecular weight distribution (Mw/Mn) in the range from 3.0 to 10.0, wherein Mw stands for the weight average molecular weight and wherein Mn stands for the number average molecular weight and wherein Mw and Mn are measured by SEC analysis with universal calibration according to ISO16016-1(4):2003.

4. The packaging according to claim 1, wherein the random propylene copolymer is a propylene-ethylene copolymer, which propylene-ethylene copolymer has an area under the aTREF curve at and above a temperature (T) to a temperature up to 120° C. of at most 5.0% based on the total area under the aTREF curve in the temperature range from 50° C. to 120° C., wherein T=110−1.66*[C] equation 1 wherein T is the temperature in ° C., wherein [C] is the comonomer content in the random propylene copolymer in wt % wherein the aTREF curve was generated using a cooling rate of 0.1° C./min and a heating rate of 1° C./min and 1,2-dichlorobenzene as eluting solvent.

5. The packaging according to claim 1, wherein said stabilizing additive mixture is present in an amount of between 0.04 and 0.60 wt. % based on the weight of the polymer composition.

6. The packaging according to claim 1, wherein said hydroxylamine is N,N-dioctadecylhydroxylamine.

7. The packaging according to claim 1, wherein said phosphite compound is tris(2,4-di-tert-butylphenyl)phosphite.

8. The packaging according to claim 1, wherein said hindered amine light stabilizer is butanedioic acid, dimethylester, polymer with 4-hydroxy-2,2,6,6-tetramethyl-1-piperidine ethanol.

9. The packaging according to claim 1, wherein said polymer composition further comprises a clarifier additive.

10. The packaging according to claim 1, wherein said polymer composition is free of phenolic additives.

11. The packaging according to claim 1, wherein said polymer composition is phthalate-free.

12. The packaging according to claim 1, wherein said random propylene copolymer has a melt flow rate (MFR) of between 36 and 44 dg/min measured according to ISO 1133-1:2011 under 2.16 kg load and/or a density of between 890 and 920 km/m³ measured according to ISO 1183-1:2012; and/or an ethylene content of between 3.8 and 4.2 wt. %.

13. The packaging according to claim 12, wherein said random propylene copolymer has a melt flow rate (MFR) of between 36 and 44 dg/min measured according to ISO 1133-1:2011 at 230° C. under 2.16 kg load, a density of between 890 and 920 km/m³ measured according to ISO 1183-1:2012; and an ethylene content of between 3.8 and 4.2 wt. %.

14. The packaging according to claim 1, wherein said packaging has a b value of at most 4.0 after having being subjected to at least 35 kGy gamma radiation, preferably at least 55 kGy gamma radiation or at least 40 kGy electron beam radiation.

15. The packaging according to claim 1, wherein said packaging has a MFI of at most 60 dg/min after having being subjected to at least 4 extrusion passes.

16. (canceled)
